(19) United States
(12) Patent Application Publication
(10) Pub. No.: US 2026/0054102 A1
(43) Pub. Date: Feb. 26, 2026

(54) RESPIRATORY SYSTEM, IN PARTICULAR FOR AN AIRCRAFT, WITH REGULATION OF THE PROPORTION OF OXYGEN

(71) Applicant: SAFRAN AEROSYSTEMS, PLAISIR (FR)

(72) Inventors: Matthieu Luc FROMAGE, MOISSY-CRAMAYEL (FR); Jean-Baptiste DUPUY, MOISSY-CRAMAYEL (FR); Vincent Jean Pierre Marie GILLOTIN, MOISSY-CRAMAYEL (FR)

(21) Appl. No.: 18/997,598

(22) PCT Filed: Jul. 17, 2023
(86) PCT No.: PCT/FR2023/051098

§ 371 Date: Jan. 22, 2025

(30) Foreign Application Priority Data
Jul. 27, 2022 (FR) 2207746

(51) Int. Cl. A62B 7/14

(52) U.S. Cl. CPC A62B 7/14

(57) ABSTRACT

A breathing system, in particular for an aircraft, includes a distribution member to deliver a gas mixture to at least one occupant, a gas mixture inlet connected to a source of breathable gas and having an intake valve for regulating a proportion of breathable gas in the gas mixture, a diluent gas inlet, connected to a source of diluent gas and having a diluent gas inlet valve for regulating a proportion of diluent gas in the gas mixture, at least one sensor for measuring a proportion of breathable gas in the gas mixture delivered by the distribution member, and a control system for regulating the delivered proportion of breathable gas as a function of the measured information and to control the gas mixture intake valve and the diluent gas inlet valve as a function of the delivered proportion of breathable gas and a desired proportion of breathable gas.

### TECHNICAL FIELD OF THE INVENTION

The invention relates to regulating the proportion of oxygen delivered by a breathing system, in particular for occupants of an aircraft.

More specifically, the invention relates to a breathing system, in particular for an aircraft, as well as to a method for controlling such a system.

### PRIOR ART

The delivery of a gas mixture containing oxygen to the occupants of an aircraft through a mask connected to a source of breathable gas. Such a source of breathable gas may be a gas mixture which may include oxygen or air highly enriched with oxygen, stored in one or more cylinders or in reserves of pressurized oxygen arranged on board the aircraft.

The oxygen supply may be replaced by an onboard oxygen generation system, such as one or more onboard oxygen generation systems (also referred to by the acronym OBOGS) supplied with air from the compressor of one or more of the engines.

The onboard oxygen generation system may also comprise a molecular sieve oxygen generating system (also referred to by the acronym MSOGS) arranged to provide oxygen-enriched air at a desired oxygen concentration by adsorbing nitrogen from the air supplied to the system.

Such distribution is intended to ensure that the occupants are protected against hypoxia, for example in the event of depressurization of the aircraft cabin, against the presence of smoke and/or vapors in the aircraft cabin, in particular in the event of an accident, or against the effects of acceleration, in the case of military aircraft.

The gas mixture may also comprise a diluent gas, for example ambient air or air from a source of compressed air.

Controlling the proportion of oxygen in the gas mixture is crucial, in particular to avoid delivering too little oxygen for effective operation. Indeed, oxygen under-consumption poses safety problems, because the occupant is not properly protected against hypoxia. This is all the more detrimental and the risk of error is increased when the occupant is an aircraft pilot, since hypoxia can lead to the pilot losing consciousness.

Conversely, oxygen over-consumption depletes the oxygen reserves. This reduces autonomy in the oxygen distribution. This is all the more detrimental and the risk of error is increased when the occupant is an aircraft pilot, particularly of a military aircraft, because the reduced autonomy in the oxygen distribution can result in having to cut a flight short.

In addition, the desired proportion of oxygen is likely to vary according to the conditions and the occupants, depending on the criticality of the roles they play.

An oxygen mask may function by using dilution on demand: the diluent gas and oxygen are injected when the occupant wearing the mask inhales. Inhalation is detected when there is negative pressure in the mask, in particular by a differential pressure sensor or by a relative pressure sensor, for electronically controlled management of the oxygen proportion, or by a membrane, for mechanical control of the oxygen proportion.

In general, dilution takes place continuously; the diluent gas and oxygen are injected at the same time into the mask, where they are consumed.

To do this, one common solution is to inject oxygen under pressure through a venturi tube placed in a capsule. The capsule volume may be in communication with the outside, so that acceleration of the oxygen in the venturi tube creates negative pressure which sucks in the diluent gas, such as ambient air, with which it is mixed.

Such a technique is purely mechanical. Thus, the level of dilution is ensured by the geometry of the venturi tube, as well as by an altimetric capsule which reduces the passage for diluent gas as altitude is gained, hence there is an increasing proportion of oxygen as altitude is gained.

In such a device, dilution of the oxygen/diluent gas mixture provided to the occupant wearing the mask, as a function of the altitude. To achieve this, the diluent gas is carried along by the venturi effect created by an injector having a variable cross-section, fed by the oxygen flow which comes from opening the main valve. The dilution is adjusted as a function of the altitude by means of a capsule, such as an aneroid capsule, which obstructs a diluent gas inlet and thus increases the supplied proportion of oxygen.

One variant consists of controlling the dilution electronically. Thus, as described in documents EP 2 010 296 and EP 1 765 444, the flow rate of injected air is measured using a pressure sensor placed at the neck of the venturi tube. Such a measurement, plus knowledge of the barometric pressure, makes it possible to calculate the oxygen flow rate required to reach a desired proportion of oxygen. Such an oxygen flow rate is then obtained by adjusting, via an electronically controlled valve, the oxygen pressure upstream of a calibrated orifice.

Furthermore, it is known to carry out a separate injection of oxygen and of diluent air, developed in phase-dilution techniques. Thus, a successive injection of pure oxygen then of diluent air is carried out in order to supplement the inhalation, during the same inhalation cycle. In addition, it is known, in particular from document FR 2 334 374, that a combined oxygen/air valve is used to inject oxygen and diluent air separately, blocking one relative to the other and vice versa. Such a technique makes it possible to relocate the regulator, but it requires measuring the duration of an inhalation. Indeed, the combined oxygen/air valve is controlled based on an opening time that is indexed to the duration of an inhalation.

However, such systems do not allow very precise control over the proportion of oxygen in the gas mixture actually delivered to an occupant wearing the mask. This lack of precision prevents taking into account drifts in the system, which can lead to serious consequences, in particular when the amount of oxygen delivered is overestimated.

Furthermore, these systems do not take into account the loss of some of the oxygen to a “dead volume” at the end of an inhalation, which does not enter the lungs and remains in the trachea where it is not used by the body.

### PRESENTATION OF THE INVENTION

The invention aims to remedy the above disadvantages by proposing a dilution system which allows precise and reliable control of the proportion of oxygen delivered to a user or to an occupant.

To this end, the invention relates to a breathing system, in particular for an aircraft, comprising:
a distribution member, adapted to deliver a gas mixture to at least one occupant,
a gas mixture inlet, able to be connected to a source of breathable gas, comprising a gas mixture intake valve intended to regulate a proportion of breathable gas in the gas mixture,
a diluent gas inlet, able to be connected to a source of diluent gas, comprising a diluent gas inlet valve intended to regulate a proportion of diluent gas in the gas mixture,
at least one sensor, adapted to measure information representative of a proportion of breathable gas in the gas mixture delivered by the distribution member, and
a control system, configured to regulate the delivered proportion of breathable gas as a function of the measured information and to control the gas mixture intake valve and the diluent gas inlet valve as a function of the delivered proportion of breathable gas and a desired proportion of breathable gas.

Such a system makes it possible to implement a feedback loop for adjusting the delivered proportion of breathable gas to be as close as possible to the set value and to maintain it despite a possible change in the breathing conditions and/or in the occupant's breathing pattern.

The breathable gas may, for example, be pressurized oxygen coming from a storage cylinder. Furthermore, the diluent gas may, for example, be ambient air.

The distribution member may comprise in particular a mask, intended to be worn on the face of the occupant who is the mask wearer, and a pipe, suitable for allowing the circulation of the gas mixture and/or the breathable gas.

The diluent gas inlet valve is in particular an “all or nothing”type of valve.

The information representative of the proportion of breathable gas may be a measurement of the volume fraction and/or the mass fraction of breathable gas, a ratio of flow rates in the gas mixture intake valve and/or diluent gas inlet valve, a blood gas level of breathable gas in the occupant wearing the mask, or other information.

The sensor may comprise a first flow meter, adapted to measure a flow rate of breathable gas through the gas mixture intake valve, and/or a second flow meter, adapted to measure a flow rate of diluent gas through the diluent gas inlet valve, and/or an oxygen sensor, and/or a physiological sensor.

The flow meters used may come from various technologies: thermal (hot-wire probe type), sonic (Doppler effect type) or mechanical (cantilever or Coriolis effect type) or based on a pressure measurement (laminar, orifice plate, venturi, etc.).

Alternatively, at least one of the sensors may comprise an oxygen sensor and/or a physiological sensor.

The distribution member may comprise a mask and a means for detecting an inhalation phase, notably a pressure sensor that is adapted in particular to measure a pressure in an internal space of the mask.

Such a feature makes it possible to obtain information about the breathing cycle of the occupant wearing the mask.

The control system may be configured to detect inhalations of the occupant and to vary flow rates and/or volumes through the gas mixture intake valve and/or through the diluent gas inlet valve, over the course of a breathing cycle.

Such a feature makes it possible to implement a dilution in phases, and to adjust the dilution to the breathing rate of the mask wearer.

The control system may be configured to control the gas mixture intake valve and the diluent gas inlet valve to deliver:
gas mixture during at least one initial phase of a breathing cycle, this gas mixture comprising for example at least 60% breathable gas, in particular at least 75% breathable gas, and more particularly at least 90% breathable gas, and
gas mixture during at least one final phase of the breathing cycle, this gas mixture comprising for example at least 60% diluent gas, in particular at least 75% diluent gas, and more particularly at least 90% diluent gas.

The initial phase takes place before the final phase during a single breathing cycle.

Such a feature makes it possible to avoid losses of breathable gas to the breathing dead volume that does not reach the lungs.

The control system may be configured to calculate an average proportion of breathable gas delivered during the breathing cycle and to adjust the flow rates through the gas mixture intake valve and diluent gas inlet valve during subsequent inhalations, based on the average proportion of breathable gas.

Such a feature allows adjusting the flow rates to bring the proportion of breathable gas in the delivered mixture closer to the desired proportion of breathable gas.

The control system may be configured to measure, repeatedly during the breathing cycle, the flow rates through the gas mixture intake valve and/or through the diluent gas inlet valve, and to control the gas mixture intake valve and the diluent gas inlet valve according to the delivered proportion of breathable gas and the desired proportion of breathable gas.

Such a feature allows the delivered proportion of breathable gas to converge more quickly towards the desired proportion.

The control system may be configured to control the gas mixture intake valve and/or the diluent gas inlet valve to deliver, during an intermediate phase of the breathing cycle, the gas mixture comprising both breathable gas and diluent gas, one among the gas mixture intake valve and/or the diluent gas inlet valve operating at a maximum flow rate.

The intermediate phase temporally takes place between the initial phase and the final phase during a single breathing cycle.

Such a feature makes it possible to compensate for a possible limit on the flow rate in one of the valves, by introducing the missing amount of gas during the intermediate phase. It is thus possible to smooth the transition between the initial phase and the final phase.

The control system may be configured to control the gas mixture intake valve and/or the diluent gas inlet valve to deliver, during a transition phase of the breathing cycle, the gas mixture comprising both breathable gas and diluent gas, the flow rate of breathable gas decreasing while the flow rate of diluent gas increases.

The control system may be configured to perform a calculation to correct the proportion of breathable gas in the delivered gas mixture, this calculation being proportional or proportional-integral, based on the delivered proportion of breathable gas and the desired proportion of breathable gas.

Such a feature makes it possible to correct a constant bias error, which a simple proportional corrector would not be able to correct in a simple manner.

The invention also relates to a method for controlling a proportion of breathable gas in a gas mixture delivered by a breathing system as defined above, comprising at least:
a distribution step, during which a gas mixture comprising a proportion of breathable gas and a proportion of diluent gas is distributed;
a measurement step, during which at least one sensor measures information representative of a proportion of breathable gas in the gas mixture delivered,
a calculation step, during which a control system calculates the delivered proportion of breathable gas,
a deviation calculation step, during which the control system calculates the deviation between the delivered proportion of breathable gas and a desired proportion of breathable gas, and
a control step, during which the control system (40) controls the gas mixture intake valve and/or the diluent gas inlet valve to adjust a flow rate through the gas mixture intake valve and a flow rate through the diluent gas inlet valve as a function of at least the calculated deviation.

### BRIEF DESCRIPTION OF FIGURES

FIG. 1 is a schematic view of a breathing system according to the invention;

FIG. 2 is a representation of a control loop implemented by the breathing system of FIG. 1;

FIG. 3 is a graphical representation of the gases delivered during a breathing cycle;

FIG. 4 is a graphical representation of the gases delivered during a breathing cycle when the maximum flow rate of one of the valves becomes limiting;

FIGS. 5a and 5b are graphical representations of the gases delivered during a breathing cycle comprising a plurality of alternating distributions of a gas mixture and a diluent gas; and

FIG. 6 is a graphical representation of the gases delivered during a breathing cycle comprising a transition phase.

### DETAILED DESCRIPTION OF THE INVENTION

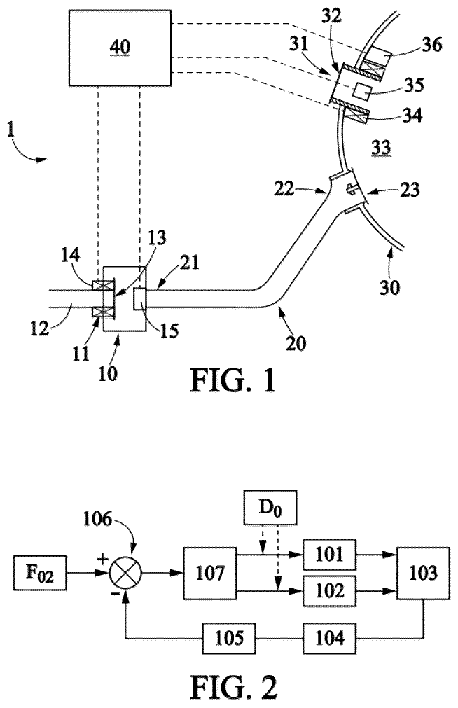

A breathing system 1, in particular for an aircraft, is schematically represented in FIG. 1. Such a breathing system 1 is intended to deliver or distribute a gas mixture comprising a breathable gas, to at least one of the occupants of an aircraft.

The distribution of a gas mixture may take place from a source of breathable gas. Such a source of breathable gas may be a gas mixture that may comprise oxygen, or molecular oxygen, the terms being used interchangeably here, or air highly enriched with oxygen, stored in one or more cylinders or in reserves of pressurized oxygen arranged on board the aircraft. The oxygen supply may be replaced by an onboard oxygen generation system, such as one or more onboard oxygen generator systems (also referred to by the acronym OBOGS) supplied with air from the compressor of one or more of the engines.

The onboard oxygen generation system may also comprise a molecular sieve oxygen generating system (also referred to by the acronym MSOGS) arranged to provide oxygen-enriched air at a desired oxygen concentration by adsorbing nitrogen from the air supplied to the system.

The occupant may be, for example, a pilot of the aircraft, whose vigilance and performance are crucial at all times. He must therefore receive a sufficient and regulated proportion of oxygen that is adapted to the critical situation that he is facing.

Breathing system 1 comprises a regulator 10, capable of delivering a gas flow into a distribution member. The distribution member comprises at least one pipe 20 suitable for allowing the circulation of the gas mixture comprising breathable gas, and a mask 30 intended for distributing the gas mixture comprising breathable gas to the occupant.

Breathing system 10 also comprises a control system 40.

Regulator 10 comprises a gas mixture inlet 11. Gas mixture inlet 11 may be connected to a source 12 of breathable gas, in particular a first source of breathable gas, for example pure oxygen from a pressurized cylinder.

In the particular example of FIG. 1, regulator 10 is a remote regulator. In particular, regulator 10 is able to be fixed to the aircraft. Regulator 10 may then be connected to mask 30 by means of pipe 20, suitable for allowing the circulation of the gas mixture comprising the breathable gas.

Alternatively, regulator 10 may be worn on mask 30 and connected to source 12 of breathable gas by pipe 20, suitable for allowing the circulation of the gas mixture comprising the breathable gas, and/or by a secondary pipe.

Gas mixture inlet 11 comprises a gas mixture intake valve 13 adapted to regulate the flow rate of the gas mixture flowing through gas mixture inlet 11.

Gas mixture intake valve 13 is in particular an electronic valve comprising a control device 14 adapted to control the flow rate of gas flowing through gas mixture intake valve 13. Moreover, gas mixture intake valve 13 may have direct or amplified actuation.

Control device 14 is, for example, piezoelectric, electromagnetic, electrostatic, pneumatic, or some other type. It may be, for example, a linear or rotary actuator.

Regulator 10 may also comprise a first sensor 15. First sensor 15 may be a flow sensor adapted to measure the flow rate of the gas mixture flowing through gas mixture intake valve 13.

First sensor 15 is, for example, a thermal sensor, in particular of the hot-wire probe type, a sonic sensor, in particular of the Doppler effect type, a mechanical sensor, in particular of the cantilever or Coriolis effect type, an aeraulic sensor, in particular of the Venturi effect type, or a pressure loss sensor.

Additionally or alternatively, pressure sensors positioned according to the geometry of gas mixture intake valve 13 and the distribution member comprising at least pipe 20 and mask 30 also make it possible to obtain a flow rate value, according to Bernoulli's principle or Poiseuille's law.

Pipe 20 is advantageously flexible, or at least partly flexible, in particular in a portion connected to mask 30. A first end 21 of pipe 20 is connected to regulator 10. A second end 22 of pipe 20 is connected to mask 30.

Pipe 20 fluidically connects gas mixture intake valve 13 to mask 30, such that the gas mixture, or breathable gas, flowing through gas mixture intake valve 13 is delivered to the occupant wearing mask 30, via an inhalation valve 23.

Mask 30 is an orinasal mask, able to be placed on the face of the occupant, or wearer, to whom the gas mixture comprising breathable gas is to be delivered. It is preferably arranged in a sealed manner on the face of the wearer of mask 30.

For this purpose, mask 30 may be provided with a retention device for ensuring that mask 30 is held on the face of the occupant. Such a retention device is, for example, an elastic harness, a bayonet fastening system, or a mechanical harness.

Mask 30 is generally concave in shape and defines an internal space 33. When mask 30 is fixed to the wearer's face, the wearer's skin closes off internal space 33 in which the wearer can inhale and exhale.

In the configuration in which regulator 10 is a remote regulator, mask 30 comprises inhalation valve 23 which pipe 20 leads to, capable of allowing the gas mixture or breathable gas to enter from pipe 20 into internal space 33.

Alternatively, in the configuration in which regulator 10 is worn on mask 30, there is no inhalation valve.

In addition, mask 30 comprises a diluent gas inlet 31 comprising a diluent gas inlet valve 32, allowing diluent gas to enter internal space 33, in particular from the outside environment.

Mask 30 also advantageously comprises an exhalation valve, not shown. The exhalation valve is suitable for allowing the expulsion of gases exhaled by the wearer.

Diluent gas inlet valve 32 may be an electronic valve comprising a control device 34 adapted to control the flow rate of gas flowing through diluent gas inlet valve 32.

Diluent gas inlet valve 32 may also comprise a second sensor 35. Second sensor 35 may be a flow rate sensor adapted to measure the flow rate of gas flowing through second valve 32. Second sensor 35 is, for example, a thermal sensor, in particular of the hot-wire probe type, a sonic sensor, in particular of the Doppler effect type, a mechanical sensor, in particular of the cantilever or Coriolis effect type, an aeraulic sensor, in particular of the Venturi effect type, or a pressure loss sensor.

Furthermore, mask 30 further comprises a pressure sensor 36, adapted to measure a pressure in internal space 33.

Control system 40 is, for example, connected to control device 14 of gas mixture intake valve 13, to control device 34 of diluent gas inlet valve 32, to first sensor 15 of regulator 10, and to second sensor 35 of diluent gas inlet 31. In addition, control system 40 may also be connected to pressure sensor 36.

Control system 40 is, for example, a circuit board, comprising at least one processor adapted to execute programs and at least one memory in which instructions are stored for the execution of these programs.

According to another embodiment, control system 40 may also be completely analog. Control system 40 may also comprise control logic or control electronics and power electronics for controlling gas mixture intake valve 13.

Control system 40 is configured in particular to measure the flow rates in gas mixture intake valve 13 and in diluent gas inlet valve 32, by making use of first sensor 15 of regulator 10 and/or second sensor 35 of diluent gas inlet 31. Control system 40 is able to calculate the proportion of oxygen in the gas mixture delivered to the wearer, based on the flow rates in gas mixture intake valve 13 and in diluent gas inlet valve 32. In addition, control system 40 is able to adjust the commands to gas mixture intake valve 13 and diluent gas inlet valve 32 based on the measured proportion of oxygen in the gas mixture and the desired proportion of oxygen in the gas mixture.

The desired proportion of oxygen in the gas mixture is, for example, stored in a memory. Alternatively, the desired proportion of oxygen in the gas mixture may be calculated from information intrinsic to breathing system 1 and from data stored in the memory. If breathing system 1 is suitable for being installed in an aircraft, the intrinsic information is the flight data in particular.

A method for controlling the proportion of oxygen in the delivered gas mixture follows a control loop implemented by breathing system 1. As shown in FIG. 2, the method for controlling the proportion of oxygen in the delivered gas mixture follows a feedback loop.

The control method provides a first actuation step 101 during which control device 14 of gas mixture intake valve 13 is actuated by control system 40, and a second actuation step 102 during which control device 34 of second valve 32 is actuated by control system 40, for example based on initial flow rate values D₀ stored in a memory. First actuation step 101 for control device 14 of gas mixture admission valve 13 and second actuation step 102 for control device 34 of second valve 32 may temporally take place successively or simultaneously.

At the end of first actuation step 101 and second actuation step 102, the control method provides a distribution step 103 during which a gas mixture is distributed to the wearer. In distribution step 103, the gas mixture comprises an initial proportion of oxygen.

Subsequently, the control method provides a measurement step 104 during which the flow rates through gas mixture intake valve 13 and diluent gas inlet valve 32 are measured respectively by first sensor 15 and second sensor 35 which are controlled by control system 40.

The ratio of the flow rates through gas mixture intake valve 13 and diluent gas inlet valve 32 constitutes information representative of the proportion of oxygen in the gas mixture delivered. To this end, the control method provides a calculation step 105 during which the proportion of oxygen in the gas mixture is calculated in control system 40.

Finally, the control method provides a deviation calculation step 106 during which the deviation between the proportion of oxygen in the gas mixture delivered and a desired proportion of oxygen in the gas mixture F_{O2} is calculated.

The deviation calculation may include an integral component, or pseudo-integral component with a cut-off frequency adapted to provide a similar result, around a breathing frequency of between 0.1 Hz and 1 Hz, in particular between 0.1 Hz and 0.75 Hz, and more specifically between 0.16 Hz and 0.75 Hz and more particularly between 0.16 Hz and 0.5 Hz.

Lastly, the control method provides a control step 107 during which new control values for gas mixture intake valve 13 and for diluent gas inlet valve 32 are then determined in order to adjust the proportion of oxygen in the gas mixture delivered.

The control method is iterated to improve the accuracy of the proportion of oxygen in the gas mixture delivered to the wearer relative to a set value.

According to one particular dilution method, distribution of the gas mixture comprising a proportion of oxygen may be done by continuous dilution.

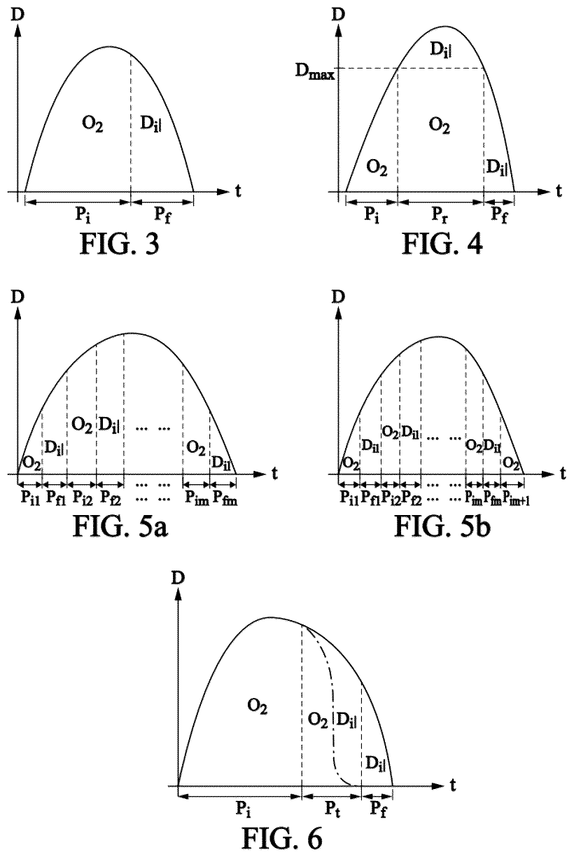

Advantageously, the dilution is carried out according to a dilution-on-demand method; the principle of this method is diagrammatically represented in FIGS. 3 and 4, which are graphical representations respectively of the gases delivered during a breathing cycle, and during a breathing cycle when the maximum flow rate of gas mixture intake valve 13 and/or diluent gas inlet valve 32 becomes limiting.

Thus, FIG. 3 is a graphical representation of the evolution of a flow rate D of the distribution of the gas mixture as a function of time t, during an inhalation of the wearer of mask 30.

The start of the inhalation of the wearer of mask 30 is detected by means of pressure sensor 36, adapted to measure a pressure in internal space 33 and controlled by control system 40. The appearance of a negative pressure in internal space 33 corresponds to the start of an inhalation and triggers the distribution of the gas mixture.

During an initial phase Pᵢ, gas mixture intake valve 13 is open and diluent gas inlet valve 32 is closed, so that the gas mixture mainly comprises breathable gas, in particular more than 90% of the flow rate is breathable gas, and advantageously only breathable gas.

The duration of initial phase Pᵢ depends on flow rate D of the gas mixture, the desired proportion of oxygen in the gas mixture, and an estimate of the inhalation volume of the wearer, such that the total volume of oxygen in the gas mixture delivered during initial phase Pᵢ corresponds to the product of the desired fraction of oxygen in the gas mixture and the inhalation volume of the wearer. The volume of oxygen in the delivered gas mixture corresponds to the area under the curve of flow rate D during initial phase Pᵢ.

At the end of initial phase Pᵢ, during a final phase P_{f}, gas mixture intake valve 13 is then closed and diluent gas inlet valve 32 is opened. During final phase P_{f}, the gas mixture mainly comprises diluent gas, in particular more than 90% of the flow rate, and advantageously only diluent gas.

Final phase P_{f} lasts until the end of the wearer's inhalation, which is associated with the disappearance of the negative pressure measured in internal space 33 and, depending on the case, with the appearance of an overpressure in internal space 33. The volume of diluent gas delivered during final phase P_{f} corresponds to the area under the curve of flow rate D during final phase P_{f}.

The sum of the volumes of oxygen and of diluent gas is recorded by control system 40 as the updated value of the inhalation volume. The proportion of oxygen actually delivered during the inhalation is calculated in order to implement the control loop described above.

Such a method allows adapting the feedback to variations in the breathing rate and in the inhalation volume of the wearer of mask 30, in particular when external conditions change, in particular during phases of stress.

In addition, the delivery of oxygen during initial phase Pᵢ makes it possible to compensate for oxygen losses to an inhalation dead volume comprising only diluent gas.

A limiting factor of the control method, and therefore of the dilution by phase, is the existence of a respective maximum flow rate Dmax of gas mixture intake valve 13 and of diluent gas inlet valve 32. Such a maximum flow rate Dmax prevents the delivery of sufficient oxygen or diluent gas to satisfy the inhalation flow rate during part of the inhalation.

This appears in particular when the inhalation is short and has a high peak in the flow rate, for example during a phase of stress. It also appears when breathing is rapid and causes discomfort during inhalation.

To overcome such a problem, as shown in FIG. 4 which is a graphical representation of the gases delivered during a breathing cycle when the maximum flow rate of one of the valves becomes limiting, control system 40 triggers an intermediate phase Pᵣ, during which the valve that is limiting the flow rate delivers its maximum flow rate. In such a configuration, the other valve delivers the additional flow rate to satisfy the inhalation flow rate.

In the example shown in FIG. 4, gas mixture intake valve 13 is the flow-limited valve and is delivering its maximum flow Dmax. Thus, diluent gas inlet valve 32 is opened in order to deliver additional flow, represented by the area located above the dashed line corresponding to the value Dmax, delimiting the maximum flow of gas mixture intake valve 13, and the continuous curve representing flow rate D as a function of time t.

The delivered proportion of oxygen is calculated geometrically by adding the areas corresponding to oxygen under the curve of flow rate D during initial phase Pᵢ and intermediate phase Pᵣ, in order to implement the feedback as described above.

In the example described, the information relating to the proportion of breathable gas is a ratio of the volumes passing through gas mixture intake valve 13 and diluent gas inlet valve 32.

Other types of information may be obtained by making use of different sensors. For example, it is possible to directly measure the fraction of oxygen in the gas mixture delivered using an oxygen sensor mounted on mask 30. Alternatively, the oxygen sensor could be positioned so as to measure the proportion of oxygen in the gases exhaled by the wearer. The information may then be advantageously supplemented by a measurement of the proportion of CO₂ in the exhaled gases, obtained with a CO₂ sensor.

Furthermore, during a same breathing cycle, it is conceivable that a plurality of initial phases Pᵢ and a plurality of final phases P_{f} occur, in particular alternating with each other. FIGS. 5a and 5b show two graphical representations of the gases delivered during a breathing cycle comprising a plurality of alternations between the distribution of a gas mixture and a diluent gas.

Thus, depending on the number of alternations and/or as a function of the duration of the breathing cycle, in particular of an inhalation of the occupant wearing mask 30, the breathing cycle is likely to end with:
a final phase P_{fm} of distributing diluent gas, as shown in FIG. 5a; or
an initial phase Pᵢₘ₊₁ of distributing a gas mixture mainly comprising breathable gas, as shown in FIG. 5b.

Alternating in this manner makes it possible to provide pure oxygen at the beginning of breathing while looping several times per inhalation cycle over the quality of the air/oxygen mixture supplied. It is thus possible to react more quickly in the event of rapid variations in an inhalation pattern, both in frequency and in amplitude.

Similarly, the volume of oxygen in the gas mixture delivered during the breathing cycle corresponds to the sum of the areas under the curve of flow rate D during the various initial phases Pᵢ₁, Pᵢ₂, . . . Pᵢₘ, Pᵢₘ₊₁. Similarly, the volume of diluent gas delivered during the breathing cycle corresponds to the sum of the areas under the curve of flow rate D during the various final phases P_{f1}, P_{f2}, . . . P_{fm}. The sum of the volumes of oxygen and of diluent gas is recorded by control system 40.

Furthermore, in order to keep the occupant who is wearing mask 30 comfortable, it may be envisaged to provide a transitional phase Pt between initial phase Pᵢ and final phase P_{f}.

During transitional phase Pₜ, distribution of the gas mixture is progressively reduced while distribution of the diluent gas is progressively increased, generating a distribution transition.

The distribution transition is represented by the dashed curve in FIG. 6 which is a graphical representation of the gases delivered during a breathing cycle comprising such a transition phase Pₜ.

The duration of transition phase Pₜ is adjustable. In particular, transition phase Pₜ may extend until the end of the breathing cycle.

Transition phase Pₜ makes it possible to avoid any risk linked to a potential absence of the distribution of gas mixture and/or of diluent gas during a switch from the initial phase to the final phase.

Indeed, the switch from the initial phase to the final phase causes an instantaneous closing of gas mixture intake valve 13 coupled with an instantaneous opening of diluent gas inlet valve 32.

Thus, due to a possible delay or mechanical hysteresis, a time period, even if minimal, may be perceptible during which there is no distribution of gas mixture and/or diluent gas. This may be felt by the occupant wearing mask 30, and lead to distracting him or even hindering him. This is all the more detrimental if the occupant wearing mask 30 is a pilot of an aircraft.

All types of physiological sensors are conceivable for finding out the physiological state of the occupant wearing mask 30, in particular the blood oxygen level of the occupant wearing the mask. It is also possible to measure the blood composition of the occupant wearing the mask, via a measurement of the arterial oxygen saturation SaO2 or a pulsoximetric measurement of the oxygen saturation SpO2. These data would be measured by an ABG analyzer (SaO2) or a pulse oximeter (SpO2), and be used to implement the feedback loop.

Furthermore, it is also possible to find out the physiological state of the occupant wearing the mask, in particular by analysis of the exhaled gases, measurement of the brain activity, and/or measurement of the blood flow of the occupant wearing the mask.

Obviously, the invention is not limited to the embodiments described above and provided solely as examples. It encompasses various modifications, alternative forms, and other variants that are conceivable to those skilled in the art within the framework of the present invention, and in particular all combinations of the various operating modes described above, which may be taken separately or in association.

1. A breathing system (1), for an aircraft, comprising:
a distribution member (20, 30), adapted to deliver a gas mixture to at least one occupant,
a gas mixture inlet (11), connectable to a source (12) of breathable gas, comprising a gas mixture intake valve (13) for regulating a proportion of breathable gas in the gas mixture,
a diluent gas inlet (31), connectable to a source of diluent gas, comprising a diluent gas inlet valve (32) for regulating a proportion of diluent gas in the gas mixture,
at least one sensor (15, 35), adapted to measure information representative of a proportion of breathable gas in the gas mixture delivered by the distribution member (20, 30), and
a control system (40), configured to regulate the delivered proportion of breathable gas as a function of the measured information, and to control the gas mixture intake valve (13) and the diluent gas inlet valve (32) as a function of the delivered proportion of breathable gas and a desired proportion of breathable gas.

2. The breathing system according to claim 1, wherein the sensor (15, 35) may comprise a first flow meter (15), adapted to measure a flow rate of breathable gas through the gas mixture intake valve (13), and/or a second flow meter (35), adapted to measure a flow rate of diluent gas through the diluent gas inlet valve (32), and/or an oxygen sensor, and/or a physiological sensor.

3. The breathing system according to claim 1, wherein the distribution member (30) comprises a mask (30) and a means for detecting an inhalation phase (36), notably a pressure sensor (36) that is adapted to measure a pressure in an internal space (33) of the mask (30).

4. The breathing system according to claim 1, wherein the control system (40) is configured to detect inhalations of the occupant and to vary flow rates and/or volumes through the gas mixture intake valve (13) and/or through the diluent gas inlet valve (32), over the course of a breathing cycle.

5. The breathing system according to claim 4, wherein the control system (40) is configured to control the gas mixture intake valve (13) and the diluent gas inlet valve (32) to deliver:
gas mixture during at least one initial phase (Pᵢ) of a breathing cycle, this gas mixture comprising at least 60% breathable gas, and
gas mixture during at least one final phase (P_{f}) of the breathing cycle, this gas mixture comprising at least 60% diluent gas.

6. The breathing system according to claim 4, wherein the control system (40) is configured to calculate an average delivered proportion of breathable gas during the breathing cycle and to adjust the flow rates through the gas mixture intake valve (13) and the diluent gas inlet valve (32) during subsequent inhalations, based on the average proportion of breathable gas

7. The breathing system according to claim 4, wherein the control system (40) is configured to measure, repeatedly during the breathing cycle, the flow rates through the gas mixture intake valve (13) and/or through the diluent gas inlet valve (32), and to control the gas mixture intake valve (13) and the diluent gas inlet valve (32) according to the delivered proportion of breathable gas and the desired proportion of breathable gas.

8. The breathing system according to claim 7, wherein the control system (40) is configured to control the gas mixture intake valve (13) and/or the diluent gas inlet valve (32) to deliver, during an intermediate phase (Pᵣ) of the breathing cycle, the gas mixture comprising both breathable gas and diluent gas, the gas mixture intake valve (13) and/or the diluent gas inlet valve (32) operating at a maximum flow rate (Dmax).

9. The breathing system according to claim 8, wherein the control system (40) is configured to control the gas mixture intake valve (13) and/or the diluent gas inlet valve (32) to deliver, during a transition phase (Pₜ) of the breathing cycle, the gas mixture comprising both breathable gas and diluent gas, the flow rate of breathable gas decreasing while the flow rate of diluent gas increases.

10. The breathing system according to claim 1, wherein the control system (40) is configured to perform a calculation to correct the proportion of breathable gas in the delivered gas mixture, this calculation being proportional or proportional-integral, based on the delivered proportion of breathable gas and the desired proportion of breathable gas.

11. A method for controlling a proportion of breathable gas in a gas mixture delivered by the breathing system (1) according to claim 1, comprising:
a distribution step (103), during which a gas mixture comprising a proportion of breathable gas and a proportion of diluent gas is distributed;
a measurement step (104), during which at least one sensor (15, 35) measures information representative of a proportion of breathable gas in the gas mixture delivered,
a calculation step (105), during which a control system (40) calculates the delivered proportion of breathable gas,
a deviation calculation step (106), during which the control system (40) calculates the deviation between the delivered proportion of breathable gas and a desired proportion of breathable gas, and
a control step (107), during which the control system (40) controls the gas mixture intake valve (13) and/or the diluent gas inlet valve (32) to adjust a flow rate through the gas mixture intake valve (13) and/or a flow rate through the diluent gas inlet valve (32) as a function of at least the calculated deviation.

12. The breathing system according to claim 5, wherein:
the gas mixture delivered during the at least one initial phase (Pᵢ) of a breathing cycle is at least 75% breathable gas, and
the gas mixture during the at least one final phase (P_{f}) of the breathing cycle is at least 75% diluent gas.

13. The breathing system according to claim 12, wherein:
the gas mixture delivered during the at least one initial phase (Pᵢ) of a breathing cycle is at least 90% breathable gas, and
the gas mixture during the at least one final phase (P_{f}) of the breathing cycle is at least 90% diluent gas.
